(19) United States
(12) Patent Application Publication
(10) Pub. No.: US 2012/0030062 A1
(43) Pub. Date: Feb. 2, 2012

(54) ENABLING PROXY SHOPPING

(75) Inventors: John Stauffer, Framingham, MA (US); Joseph Romney Evans, Newton, MA (US)

(73) Assignee: True Fit Corporation, Woburn, MA (US)

(21) Appl. No.: 13/192,644

(22) Filed: Jul. 28, 2011

Related U.S. Application Data
(60) Provisional application No. 61/369,009, filed on Jul. 29, 2010.

(51) Int. Cl. G06Q 30/00

(52) U.S. Cl. 705/26.7

(57) ABSTRACT

Some embodiments of the invention enable a buyer to shop for and purchase items for a recipient with confidence. For example, some embodiments of the invention enable a recipient to create a profile that may be accessed to make recommendations to a buyer on items deemed likely to suit the recipient in any of numerous ways (e.g., those deemed likely to fit the recipient, be age-appropriate, reflect the recipient's style, suit the recipient's fit preferences, conform to the recipient's measurements, etc.). In some embodiments, a recipient may indicate that certain, or all, aspects of the profile be kept private, so that the buyer need not know information about the recipient such as his/her body measurements, fit preferences, style preferences, and/or other information to be able to shop confidently for the recipient.

### RELATED APPLICATIONS

This application claims priority under 35 U.S.C. §119(e) to U.S. Provisional Application Ser. No. 61/369,009, entitled “SYSTEM FOR ENABLING PROXY-SHOPPING FOR APPAREL THAT FITS,” filed on Jul. 29, 2010, bearing Attorney Docket No. T0647.70003US00.

### FIELD OF INVENTION

This invention relates to a purchase of one or more items (e.g., items of apparel, footwear, and/or other items) by one consumer for another consumer.

### BACKGROUND

Consumers often wish to purchase items (e.g., items of apparel, footwear, and/or other items) for others. For example, one consumer may wish to purchase clothing for another as a gift. In another example, a parent may wish to purchase footwear for their child or spouse.

### SUMMARY OF INVENTION

The inventors have recognized that it can be problematic for one consumer to purchase items for another, since doing so requires that the buyer know information about the recipient, such as his/her size (or sizes), style preferences, fit preferences, etc. Moreover, even if a buyer knows what size a recipient wears for a given item of apparel, this may not be enough information to allow the buyer to confidently purchase the item for the recipient, since sizes for some items can vary widely across product brands. For example, a recipient may wear Size X of a pair of jeans made by Company A, but wear Size Y jeans made by Company B. As such, conventional techniques do not allow a buyer to shop for an item for a recipient with confidence that the item will suit (e.g., fit) the recipient.

Some embodiments of the invention provide techniques which allow a buyer to shop for and purchase items for a recipient with confidence that the items will suit the intended recipient. For example, some embodiments of the invention enable a recipient to create a “profile” to specify information such as his/her body measurements, fit preferences, style preferences and/or other information. Thereafter, the profile may be accessed so as to make recommendations to a potential buyer regarding items that may suit the recipient in any of numerous ways (e.g., those deemed likely to fit the recipient, be age-appropriate, reflect the recipient's style, suit the recipient's fit preferences (e.g., is loose, tight, etc.), conform to the recipient's measurements, and/or in other ways).

Some embodiments of the invention may preserve the recipient's privacy, in that the recipient may not be required to disclose to the buyer such information as his/her measurements, size, etc. for the buyer to be able to shop for items that suit the recipient. For example, in creating a profile, a recipient may be able to designate certain (or all) information as private, and this information may not be revealed to a potential buyer who shops for the recipient. For example, a recipient may designate his/her measurements as private, and this information may not be revealed to a buyer who shops for him/her.

Some embodiments of the invention provide recommendations to a buyer about a recipient through a “shopping agent,” which may be implemented in any of numerous ways. For example, a shopping agent may be implemented as part of an e-commerce website (e.g., as a web “widget”), via one or more applications suitable for execution on a computing device (e.g., a personal computer, mobile handheld device, and/or other computing device), in a “bricks and mortar” retail setting (e.g., as an application executing on an in-store kiosk), or in any of numerous other ways.

The foregoing is a non-limiting summary of the invention, some embodiments of which are defined by the attached claims.

### BRIEF DESCRIPTION OF DRAWINGS

FIG. 1 is a block diagram depicting an example system for implementing aspects of embodiments of the invention;

FIG. 2 is a flowchart depicting an example process for determining a likelihood that an item will suit a consumer, based at least in part on the consumer's previous experiences with other items, according to some embodiments of the invention;

FIG. 3 is a graph depicting weighted probabilities that corresponding items will suit a consumer in a given dimension, according to some embodiments of the invention;

FIG. 4 is a graph depicting a probability that an item exhibiting certain characteristics will suit a consumer, in accordance with some embodiments of the invention;

FIG. 5 is a flowchart depicting an example process whereby a recommendation regarding an item may be made to a consumer, according to some embodiments of the invention;

FIG. 6 is a representation of an example distribution of consumers according to selected attributes, according to some embodiments of the invention;

FIG. 7 is a representation of example consumer clusters identified within the distribution depicted in FIG. 6, in accordance with some embodiments of the invention;

FIG. 8 is a flow chart depicting an example process enabling a buyer to purchase, for a recipient, an item likely to suit the recipient, in accordance with some embodiments of the invention;

FIG. 9 is a screen shot representation of an example online facility which allows buyers and/or recipients to provide input relating to a purchase, in accordance with some embodiments of the invention;

FIG. 10 is a screen shot representation of an example online facility enabling a buyer to select items likely to suit a recipient, in accordance with some embodiments of the invention;

FIG. 11 is a screen shot representation of an example online facility enabling a buyer to select a recipient for which to shop, in accordance with some embodiments of the invention;

FIG. 12 is a screen shot representation of an example online facility enabling a buyer to solicit creation by a recipient of a profile, in accordance with some embodiments of the invention;

FIG. 13 is a block diagram depicting an example computer on which some embodiments of the invention may be implemented; and

FIG. 14 is a block diagram depicting an example memory on which instructions embodying aspects of the present invention may be stored.

### DETAILED DESCRIPTION

Some embodiments of the invention enable a buyer to shop for and purchase items for a recipient with confidence. For example, some embodiments of the invention enable a recipient to create a profile that may be accessed to make recommendations to a buyer on items deemed likely to suit the recipient in any of numerous ways (e.g., those deemed likely to fit the recipient, be age-appropriate, reflect the recipient's style, suit the recipient's fit preferences, conform to the recipient's measurements, etc.). In some embodiments, a recipient may indicate that certain, or all, aspects of the profile be kept private, so that the buyer need not know information about the recipient such as his/her body measurements, fit preferences, style preferences, and/or other information to be able to shop confidently for the recipient.

To provide recommendations to a buyer regarding a recipient, some embodiments of the invention provide a “shopping agent” which may access the recipient's profile. A shopping agent may be implemented in any of numerous ways, including as part of an e-commerce website, via one or more applications suitable for execution on a computing device (e.g., a personal computer, mobile handheld device, and/or other computing device), in a “bricks and mortar” retail setting (e.g., via an in-store kiosk), or in any of numerous other ways. As a result, a buyer may choose any of several options for purchasing items likely to suit a particular recipient.

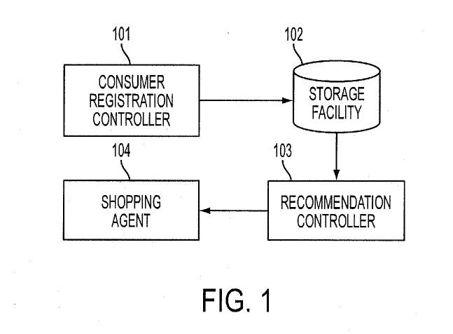

FIG. 1 depicts components of an example system 100 which enables a buyer to purchase items for a recipient that are likely to suit the recipient. Certain components of example system 100 may generically be considered to comprise one or more controllers for performing functions described below. A controller may be implemented in any of numerous ways, such as with dedicated hardware and/or by employing one or more processors programmed using software and/or microcode to perform described functions. When implemented via software, programmed software code may be executed on any suitable processor or collection of processors, whether provided in a single computer or distributed among multiple computers. Where a controller accepts or provides data for system operation, the data may be stored in a central repository or a plurality of repositories. Embodiments of the invention are not limited to any particular manner of implementation.

The example system 100 depicted in FIG. 1 includes consumer registration controller 101, storage facility 102, recommendation controller 103, and shopping agent 104. Some example functions of, and communications between, these components are described below.

Consumer registration controller 101 provides a facility whereby information may be entered about a recipient, to support the creation of a profile for the recipient. Any of numerous types of information may be entered. For example, entered information may include the recipient's age, gender, body shape, item preferences (e.g., brands and sizes of clothing that fit the recipient well), body shape attributes (e.g., stomach shape, seat shape, body shape, etc.), and/or other attributes.

It should be appreciated that a profile need not be created by the recipient. For example, a parent may enter the information about a child, so that the child's profile may be shared with the child's grandparents or other relatives.

In some embodiments, consumer registration controller 101 may enable the party that enters the information about the recipient to designate some or all of the information as private, and/or limit access to the information to certain individuals. As an example, consumer registration controller 101 may enable a recipient to mark certain body measurements (e.g., waist size, inseam size, etc.) as private, so that no one except designated individuals can view this information. Further, some embodiments may, if certain information is designated as private, prevent a recommendation that is issued to a buyer from including certain information. For example, if a recipient designates her waist and inseam sizes as private, then a recommendation issued to a buyer regarding a pair of pants for the recipient may not indicate a pant size, since the buyer may be able to infer an approximate waist and/or inseam size from this information. Rather, the recommendation may simply indicate that an appropriate size for the recipient will be selected.

Once a profile is created, consumer registration controller 101 may, in some embodiments, enable the profile to be shared with others. This may be accomplished in any of numerous ways. For example, consumer registration controller 101 may allow a recipient to e-mail their profile to another person, publish the profile via a social networking website, make it accessible to others via an e-commerce website, or take advantage of any of numerous other sharing techniques.

In some embodiments, consumer registration controller 101 enables a recipient to identify one or more items (e.g., items of apparel or footwear) that he/she believes suit him/her especially well. As an example, an identified item may be an item of apparel which the recipient already owns, and is believed to fit the recipient especially well. Consumer registration controller 101 may enable a recipient to specify sizes of individual items, sizes of items within a brand category (e.g., pants, tops, etc.), and/or any other collection of items.

Consumer registration controller 101 may be accessed to create a profile in any of numerous ways. For example, in some embodiments, consumer registration controller 101 may provide a user interface which is accessed from an e-commerce website, from within an application (e.g., adapted for execution on a handheld mobile device, such as a smartphone or PDA), from within a “bricks and mortar” retail setting (e.g., on a kiosk and/or other terminal), or in any of numerous other ways. An example interface accessed from an e-commerce website is described below.

Storage facility 102 stores recipient profile information which is collected by consumer registration controller 101. As noted above, this information may include, for example, an intended recipient's preferences, measurements, favored items, and/or other information. Storage facility 102 may also store information regarding various items (e.g., technical dimension data on certain sizes of items and/or other attributes), information regarding items that the consumer previously purchased and/or returned, survey information indicating how items purchased by consumers have fit, information on previous consumer returns of items (e.g., whether an item was returned due to fit-related issues and, if so, the nature of the issue(s) (e.g., the waist was too tight, leg too short, thigh too loose, etc.), and/or other information. Although depicted in FIG. 1 as a single repository, storage facility 102 may store data in any suitable number of repositories, in any suitable form. Embodiments of the invention are not limited in this respect.

Recommendation controller 103 accesses data stored in storage facility 102 to generate a recommendation regarding items likely to suit a recipient. In some embodiments, a request for a recommendation may be submitted to recommendation controller 103 by shopping agent 104, which may cause recommendation controller 103 to query storage facility 102 for profile information regarding the recipient. A request may be for any of numerous types of recommendations. For example, a request may be for a recommendation of an item of apparel that the recipient will enjoy. To satisfy such a request, recommendation controller 103 may query storage facility 102 to determine information on the recipient including his/her measurements, stylistic preferences, fit preferences, etc., to identify one or more items that the recipient is likely to enjoy. A request may also be for a size of a particular item (e.g., of apparel) that will fit the recipient. To satisfy this type of request, recommendation controller 103 may query storage facility 102 to determine information on the recipient including his/her measurements, as well as dimension data for the item, so that a size of the item likely to fit the recipient can be identified.

A buyer may, in some embodiments, submit a request for a recommendation via shopping agent 104. Shopping agent 104 may be implemented in any of numerous ways. In some embodiments, shopping agent 104 may comprise software code defining presentation of a user interface. The software code may be adapted for execution by a web browser (e.g., shopping agent 104 may form part of an e-commerce web site), mobile device (e.g., shopping agent 104 may include an application for execution on a smartphone, PDA, etc.), computing device (e.g., shopping agent 104 may include an application for execution on a kiosk in a retail setting), and/or any other suitable component(s).

Shopping agent 104 may enable a buyer to identify a recipient for which he/she wishes to shop, and then submit a request for a recommendation for items suitable for the identified recipient to recommendation controller 103. As noted above, a request may be for any of numerous types of recommendations, such as for items which the recipient is likely to enjoy, a size of a particular item that is likely to fit the recipient, or for other information. When a recommendation is requested, shopping agent 104 may present it to the buyer. For example, shopping agent 104 may present information on items likely to suit the recipient's style and/or fit preferences (e.g., directing the buyer to items exemplifying preferences of the intended recipient with respect to size, color, ease of fit, age appropriateness, style, etc.), enable a buyer to complete a purchase a particular item in a size likely to fit the recipient (and perhaps indicating that the recipient has indicated a preference for that size to remain private), and/or other information.

It should be appreciated that embodiments of the invention are not limited to presenting recommendations on items that will fit (i.e., have appropriate physical dimensions for) an intended recipient. Any of numerous item attributes may be analyzed to determine the likelihood that an item will suit a particular recipient, from any number of standpoints. For example, a recommendation may relate to items that suit a recipient from an age, ease of fit, style, color, and/or other standpoint. Embodiments of the invention are not limited in this respect.

Any of numerous techniques may be used to generate a recommendation. Some example techniques are disclosed in commonly assigned U.S. Provisional Patent Application No. 61/368,334, entitled “Determining A Likelihood Of Suitability Based On Historical Data,” filed Jul. 28, 2010, bearing Attorney Docket No. T0647.70001US00 (“the '334 application”), and U.S. Provisional Patent Application Ser. No. 61/368,401, entitled “Fit Recommendation Via Collaborative Inference,” filed Jul. 28, 2010, bearing Attorney Docket No. T0647.70002US00 (“the '401 application”). Relevant portions of the '334 and '401 applications are reproduced herein to describe example techniques for generating a recommendation.

In the '334 application, techniques are described determining the likelihood that an item will suit a consumer from a fit and/or style standpoint, using objective data produced as a result of the consumer's experiences with other items. For example, information on a consumer's experiences with particular products (e.g., purchase and return history, identification of “favorite” items, etc.) and data regarding attributes of those items (e.g., technical dimension data, stylistic and fit attributes, etc.) may be analyzed to determine the consumer's measurements and fit and/or style preferences, so that a prediction on how a particular size of an item may fit and otherwise suit the consumer may be made.

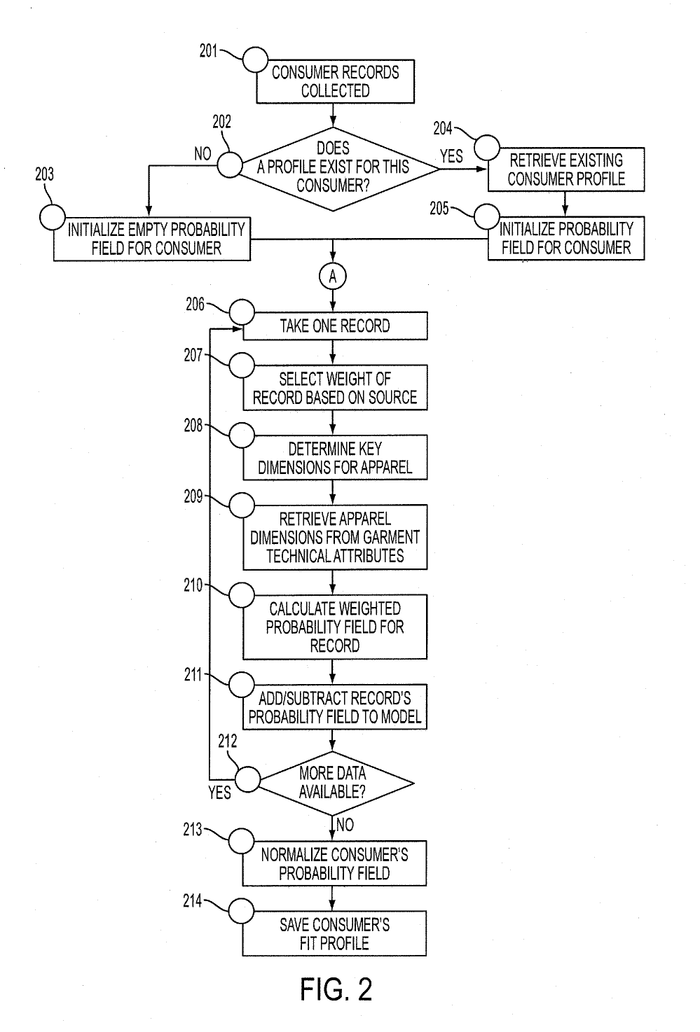

FIG. 2 depicts an example process 200, also described in the '334 application, whereby a profile is generated for a particular consumer (e.g., recipient) from data relating to that consumer. Example process 200 represents merely one example of an algorithmic approach that may be used to infer a consumer's measurements and/or style/fit preferences using objective data gleaned from the consumer's experiences with certain items. Any of numerous other algorithmic approaches may alternatively be employed, including a Bayesian network, and/or one or more other approaches.

At the start of example process 200, data about the particular consumer's experience with items of apparel is collected (e.g., retrieved from storage facility 102) in act 201. This data may include, for example, information on items the consumer believes suits him/her especially well, information on various items (e.g., technical dimension data on certain sizes of items and/or other attributes), information regarding items that the consumer previously purchased and/or returned, survey information indicating how items purchased by consumers have fit, information on previous consumer returns of items (e.g., whether an item was returned due to fit-related issues and, if so, the nature of the issue(s) (e.g., the waist was too tight, leg too short, thigh too loose, etc.), and/or other information.

Example process 200 then proceeds to act 202, wherein a determination is made whether a fit profile already exists for the consumer or not. This determination may be made, for example, by querying storage facility 102 to determine whether a fit profile for the consumer is stored. Based on the result of this determination, process 200 may proceed to retrieve the consumer's profile (if one previously existed) in act 204 and initialize that profile for updates in act 205, or to initialize a new profile for the consumer (if none previously existed) in act 203. In some embodiments, initializing a new profile for the consumer may involve generating an indication of an even probability that any apparel dimension will suit the consumer, indicating that not enough information has been collected to predict that any value for a dimension will fit the consumer.

At the conclusion of either of acts 203 or 205, process 200 proceeds to act 206, wherein a first record, reflecting the consumer's experiences with a first item, is retrieved from the data collected in act 201. In act 207, a weighting factor for the record is selected. In this respect, some embodiments may provide for ascribing greater importance to certain consumer experiences, such as those which resulted in an affirmative representation that an item suited or did not suit the consumer. For example, a record indicating that a certain item was designated as a favorite may be ascribed greater importance (e.g., by assigning it greater weight) than a record indicating that an item was purchased and not returned, since an affirmative representation may be deemed more indicative of the consumer's feelings toward an item than a purchase which was not returned.

Example process 200 then proceeds to act 208, wherein key dimensions known to be predictive of fit are identified. Any of numerous techniques may be used to identify key dimensions. In some embodiments, key dimensions may depend on the category of item for which a fit is to be predicted. For example, if the item is a shirt, then neck arm length and overall length dimensions may be identified as key dimensions. If the item is a pair of pants, then waist, rise and inseam dimensions may be identified as key dimensions. Any one or more dimensions may be designated as key dimensions for any category of item.

Example process 200 then proceeds to act 209, wherein dimension data for the first item that corresponds to the key dimensions identified in act 208 are retrieved. In some embodiments, dimensions may be retrieved from storage facility 102. For example, values may be retrieved for each key dimension for the first item. In some cases, values for some or all of the key dimensions may be expressed as a range of values, which may account for dimensional tolerances during manufacturing and “ease values” reflecting the intended fit of the item (e.g., tight, loose, etc.).

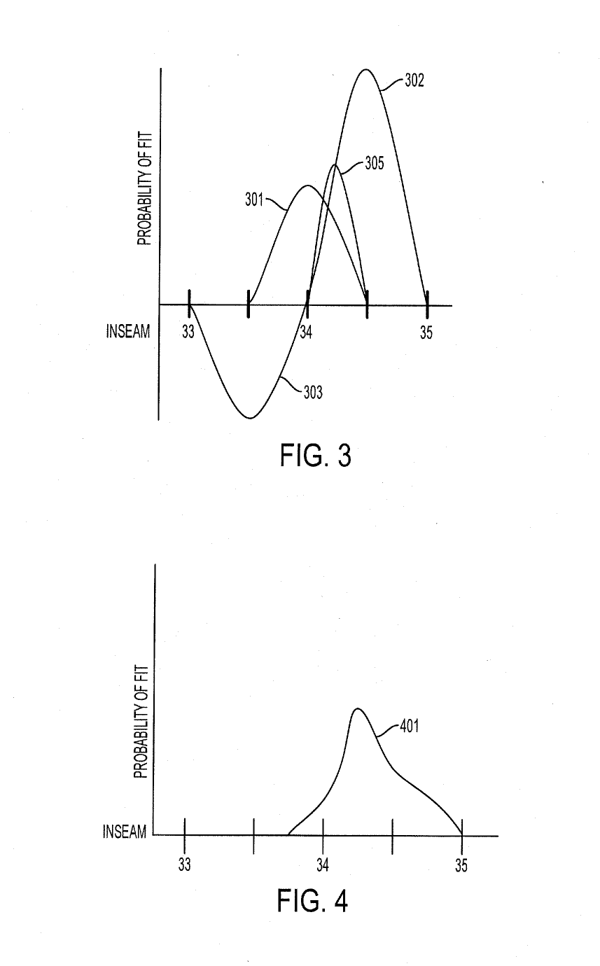

Example process 200 then proceeds to act 210, wherein a weighted probability that the item will fit the consumer in a given dimension is calculated. One example technique for calculating a weighted probability is described with reference to FIG. 3. Of course, it should be appreciated that a weighted probability may be calculated for any number of dimensions, as the invention is not limited in this respect. For example, act 210 may involve calculating a weighted probability for each key dimension identified in act 208.

In act 211, the weighted probability calculated in act 210 is added (e.g., if positive) or subtracted (e.g., if negative) to a most current statistical fit model for the dimension for the consumer in act 211. An example approach for updating a weighted probability for a dimension that an item will fit a consumer in a given dimension is described below with reference to FIG. 4. A fit model may be updated for any suitable number of dimensions, such as each key dimension identified in act 208.

In act 212, a determination is made whether any dimension data for additional items was collected in act 201. If so, process 200 returns to act 206, and repeats until all dimension data is processed.

Example process 200 then proceeds to act 213, wherein the consumer's fit model is normalized. In some embodiments, normalization may be accomplished by dividing the model for each dimension by the sum of the weights used to generate weighted probability values, although other techniques may alternatively be employed. As a result, act 213 results in an estimation of a range of dimensions, each with corresponding probability, of suiting the consumer. Items with known dimensions, or for which dimensions may be inferred, may be compared to these dimensions to estimate how those items may suit the consumer.

In act 214, the normalized model generated in act 213 is stored as part of the consumer's profile (e.g., in storage facility 102). In some embodiments of the invention, the normalized model may be stored in a format which represents the shape of the resulting curve in each dimension. For example, normalized model may be stored as a series of numbers that provide an estimated shape of the curve for each dimension. Other embodiments may utilize parameterized curve shapes to store the normalized model as pre-defined mathematical functional form. Still other embodiments of the invention may employ other techniques. Any of numerous techniques may be employed. Example process 200 then completes.

FIG. 3 illustrates an example approach for calculating a weighted probability for each of a plurality of items. In this respect, FIG. 3 depicts a Cartesian coordinate system having two axes, with the Y axis measuring the probability that an inseam dimension measured on the X axis will fit the consumer. The curves for the different items are then combined to create the composite curve shown in FIG. 4, from which conclusions about other items for which dimension data is known can be drawn.

The curve for each item represented in FIG. 3 represents example inseam data for one of products 1-5 in Table 1.

TABLE 1
Example Product Data.

| | Waist | | Target Age |
|---|---|---|---|
| Product | Circumference | Inseam | Range |
| 1 | 29.5″-30.5″ | 33.5″-34.5″ | 25-35 |
| 2 | 29″-30″ | 34″-35″ | 25-45 |
| 3 | 29″-30″ | 33″-34″ | 25-35 |
| 4 | 29″-30″ | 34″-35″ | 35-45 |
| 5 | 29″-30″ | 34″-34.5″ | 25-35 |
| 6 | 29″-30″ | 34.5″-35″ | 25-45 |

It can be seen from Table 1 that Item 1 has an inseam dimension of 33.5″-34.5″ (expressed to account for manufacturing tolerance and design ease), and was purchased successfully once by the subject consumer. As a result, in the graph shown in FIG. 3, Item 1 is represented by curve 301 as a parabolic function which is centered on the 33.5″-34.5″ range (i.e., on 34″). It should be appreciated that although parabolic functions are used to represent weighted probabilities in FIG. 3, any of numerous other functional forms could alternatively be used (e.g., Gaussian probability distribution function, Gamma function, etc.).

It can be seen from the information in Table 1 that Item 2 has an inseam dimension of 34-35″, and so Item 2 is represented by curve 302, centered in the 34-35″ range (i.e., at 34.5″) in FIG. 3. The data in Table 2 indicates that Item 2 has been identified as a “favorite” by the consumer (e.g., via my closet controller 3, or one or more other components), and so Item 2 is given twice as much weight as (i.e., assigned a probability of properly fitting in the inseam dimension that is twice as great as) Item 1.

The information in Table 1 shows that Item 3 has an inseam dimension of 33″-34″ and was returned for being too short. As a result, in this example, curve 303 for Item 3 reflects a negative probability that the item fits properly in the inseam dimension.

It can be seen from the information shown in Table 1 that Item 4 was returned because the consumer did not like the style of the item. Because this data provides no indication how Item 4 fits in the inseam dimension, Item 4 is not shown in the example representation of FIG. 3. It should be appreciated, however, that the data on Item 4 may be used to calculate probabilities that the item will suit the consumer in other dimensions (e.g., in a “Target Age Range” dimension), and may thus appear on representations analogous to FIG. 3 showing data on those dimensions.

The information in Table 1 shows that Item 5 has an inseam dimension of 34″-34.5″ and was purchased without being returned. As a result, curve 305 for Item 5 is centered in this range (i.e., over 34.25″). In the example shown, the curve 305 for Item 5 is taller than the curve for Item 1, which was also purchased and not returned but is centered over a broader dimension range. This is so that the areas beneath the curves for Item 1 and Item 5 are identical, such that each is given equal weighting with respect to predicting fit in the inseam dimension.

FIG. 4 shows an example representation generated by combining the weighted probabilities reflected in FIG. 3. The curves of FIG. 3 may be combined in any of numerous ways, as embodiments of the invention are not limited in this respect. In the example shown, the curve 401 of FIG. 4 is generated by adding all of the curves shown in FIG. 3, and then dividing by a sum of curve weights. In the example shown, the curve 302 for Item 2 has a weight of 2.0 due to the item being designated a favorite, and the curves 301, 303 and 305 for Items 1, 3 and 5, respectively, each have a weight of 1.0. By combining the curves in this manner, the resulting curve 401 is normalized to the same scale as may be calculated for other dimensions for the consumer.

The curve 401 in FIG. 4 is a curve which represents a normalized probability (measured on the Y axis) that an inseam dimension (measured on the X axis) will fit the consumer. Using this information, conclusions can be drawn regarding other items having known dimensions. For example, it can be seen that another item that has an inseam dimension that is shorter than 33.75″ has zero probability of fitting the consumer properly. Conversely, an item having an inseam dimension of approximately 34.25″ has the greatest probability of fitting the consumer properly.

Curves (and/or other functional forms) like that which is shown in FIG. 4 may be generated for any number of dimensions, as the invention is not limited in this respect. Further, a dimension need not reflect a physical dimension of an item, and may reflect any one or more attributes for which a consumer may exhibit a preference, such as style attributes, etc. Embodiments of the invention are not limited in this respect.

Curves (and/or other functional forms) like curve 401 shown in FIG. 4 for each of multiple dimensions may be combined to reflect an overall probability that a particular item will fit the consumer (e.g., recipient), and therefore used to make a recommendation regarding which items will fit the consumer.

Another example technique for generating a recommendation, described in the '401 application, involves making a fit recommendation regarding an item in an instance where technical data on different sizes of the item is unavailable. In this example technique, a fit recommendation may be made for a subject consumer with regard to a subject item by identifying one or more clusters of consumers with fit characteristics similar to the subject consumer, and/or clusters of products with purchase histories similar to that of the subject item. Information on consumers in the cluster to which the subject consumer belongs, and/or information on products in the cluster to which the subject item belongs, may be used to draw conclusions on how various sizes of the subject item may fit the subject consumer. As a result, a particular size of the subject item that is predicted to best fit the subject consumer may be recommended.

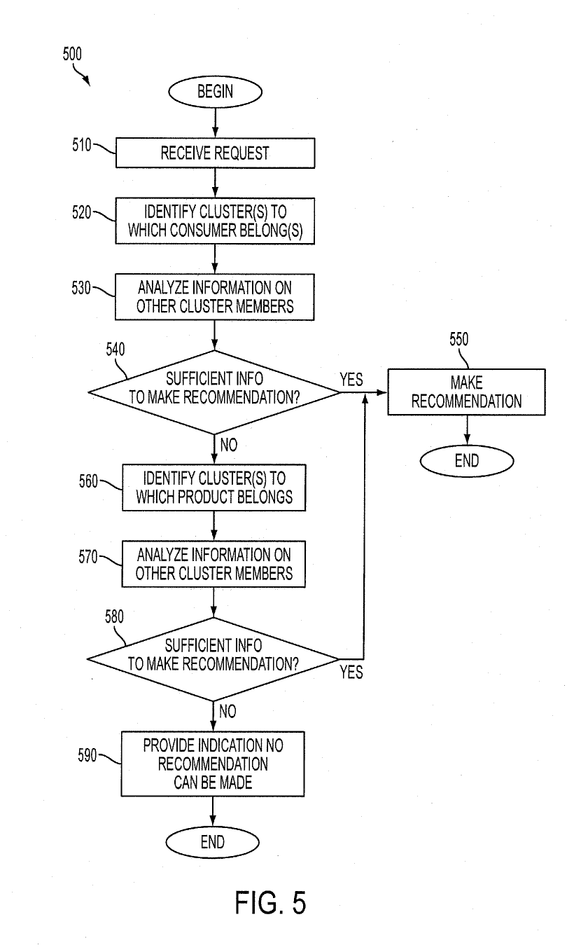

An example process 500 for generating a recommendation is depicted in FIG. 5. Example process 500 begins in act 510, in which a request for a recommendation is received. A request may, for example, identify a consumer and an item of apparel for which a recommendation is sought, although embodiments of the invention are not limited to such information being provided.

Example process 500 then proceeds to act 520, wherein a cluster to which the identified consumer belongs is identified by analyzing data stored in storage facility 102. A cluster may be defined based on commonality and/or similarity with respect to any of numerous attributes, such as those which may indicate similar fit and style preferences among consumers. For example, attributes could include consumer self-reported and/or inferred body measurements, body shape attributes (e.g., stomach shape, seat shape, body shape, etc.), sales history, and/or one or more other attributes. In the case of sales history, if garment technical attributes are available, the attributes can take into account the actual attributes of the garments. When technical attributes are not available, purchases may be pre-processed to identify clusters of items that have common purchase histories (indicating that they have similar fit characteristics).

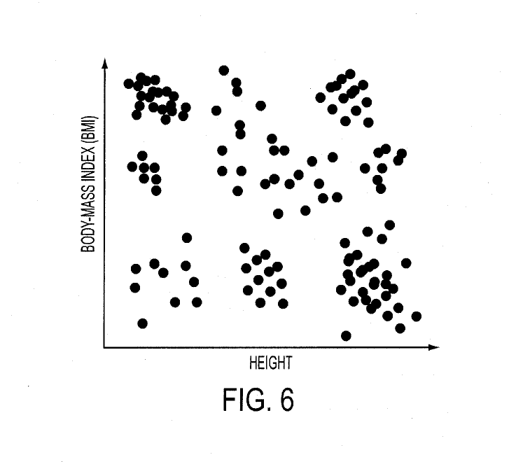

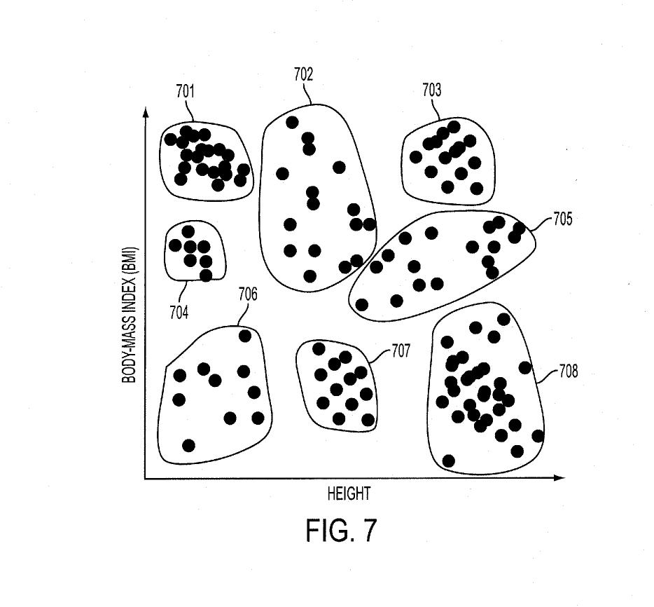

An example representation of attributes used to identify clusters among a set of consumers is depicted in FIG. 6. In the simplified example shown in FIG. 6, the attributes include height and Body Mass Index (BMI). FIG. 6 thus depicts a distribution of the sample set of consumers using these attributes. One or more data partitioning algorithms may be used to identify clusters of consumers from among the distribution shown in FIG. 6. For example, n-Means, hMetis, and/or one or more other data partitioning algorithms, which may be now known or later developed, may be used to identify clusters of consumers most similar to each other with regard to the attributes represented in FIG. 6. FIG. 7 depicts an example in which a data partitioning algorithm has been used to identify eight clusters of consumers from among the distribution depicted in FIG. 6.

It can be seen that not all clusters depicted in FIG. 6 possess the same level of similarity with respect to the attributes represented. For example, the members of group 701 are relatively localized, while the members of group 705 are more scattered. In some embodiments, the similarity or cohesiveness of each group may be reflected in a confidence rating associated with fit recommendations for members of this cluster, as described below. For example, a consumer determined to be a member of group 705 may receive a fit recommendation with a lower associated confidence rating than a member of group 701 would.

It should be appreciated that although the example described above involves identifying only a single group to which a subject consumer belongs, any suitable number of groups, each defined by any suitable one or more attributes, may be identified. Embodiments of the invention are not limited in this respect.

Returning to FIG. 5, example process 500 then proceeds to act 530, wherein information on other members of the cluster to which the consumer belongs is analyzed. For example, in some embodiments, a determination may be made whether the item for which a recommendation is sought has been successfully purchased (e.g., not returned) by one or more other members of a cluster to which the consumer belongs, and if so what size was most commonly purchased by those other consumers. Of course, it should be appreciated that embodiments of the invention are not limited to making this specific determination, and that any of numerous conclusions may be drawn by analyzing information on other members of the cluster to which the consumer belongs. As one example, if more than one size of the product was purchased by members of the cluster, then analysis may be performed on whether any size was designated by a cluster member as a favorite (or non-favorite). Embodiments of the invention are not limited to any specific type of analysis.

Example process 500 then proceeds to act 540, in which a determination is made whether sufficient information has been gathered to make a recommendation. Sufficient information may not have been gathered, for example, if the analysis of information on other members of the cluster was inconclusive (e.g., if no other members of the cluster successfully purchased the product, etc.). If sufficient information has been gathered, process 500 proceeds to act 550, wherein a recommendation is made. This may be performed in any of numerous ways, such as by causing information indicative of the recommendation to be presented on a display. Embodiments of the invention are not limited to any particular manner of making a fit recommendation.

In some embodiments, a fit recommendation may include not only a size of the item that is predicted to best fit the consumer, but also a confidence rating for the recommended size (e.g., as determined by the cohesiveness of the cluster and/or other factors), and an indication of how the item is likely to fit the consumer along key dimensions. For example, if the item in question is a pair of pants, the recommendation may include an indication of how the pants are likely to fit in the waist, hip, and/or rise areas. If the item is a shirt, the recommendation may include an indication of how the item is likely to fit the consumer in the neck, arm length, etc. Any of numerous types of information may be provided with a recommendation, as embodiments of the invention are not limited in this respect.

If it is determined in act 540 that sufficient information has not been gathered to make a recommendation, example process 500 proceeds to act 560, wherein a cluster to which the subject product belongs is identified. In this respect, in much the same way as clusters of consumers are identified based on similar style and fit preferences (e.g., as described above with reference to FIGS. 6-7), clusters of products may be identified based on fit characteristics that are inferred from consumer experience. For example, some embodiments provide for identifying clusters of products based on an analysis of sales history, to identify products that are purchased successfully by the same groups of consumers. For example, if an analysis of sales history data revealed that consumers who successfully purchased Adidas running shoes also successfully purchased New Balance running shoes, then these two brands of running shoes might be grouped into the same cluster, allowing an inference to be drawn that New Balance running shoes have fit characteristics that are similar to those of Adidas running shoes. As a result, even if data describing the dimensions of New Balance running shoes was unavailable, a size of New Balance running shoe could be recommended to a consumer based upon the knowledge that the same size Adidas running shoe has similar fit characteristics. Of course, this example which employs sales history data is merely illustrative, as any suitable information may be employed to identify product clusters.

Example process 500 then proceeds to act 570, wherein information on the other products in the cluster to which the subject product belongs is analyzed. In one example, a determination may be made whether any other member of the product cluster to which the subject product belongs has been successfully purchased by other members of the consumer cluster to which the subject consumer belongs, and if so, the size of that product may be identified. In another example, a size for a member of the product cluster that is determined to be equivalent to a size for another member of the cluster may be identified. Extending the example in the previous paragraph to illustrate, an analysis of product sales data might reveal that although both New Balance and Adidas running shoes were both successfully purchased by the same group of consumers and thus placed in the same product cluster, the purchased New Balance shoes were a half-size larger than the corresponding Adidas shoes. Based on this, a conclusion may be drawn that sizes for New Balance running shoes are on average a half-size smaller than sizes for Adidas running shoes, allowing a recommendation for New Balance running shoes to be adjusted accordingly. Any of numerous types of analysis and/or adjustments may be performed, as embodiments of the invention are not limited in this respect.

Example process 500 then proceeds to act 580, wherein a determination is made whether sufficient information has been gathered to make a recommendation. If so, process 500 proceeds to act 550, wherein a recommendation is made, as described above. If not, process 500 proceeds to act 590, wherein an indication is given to the consumer that a fit recommendation cannot be given. This indication may be provided in any of numerous ways, such as by causing information indicating that a recommendation cannot be made to be presented on a display. Embodiments of the invention are not limited to any particular manner of implementation. At the completion of act 290, process 200 completes.

It should be appreciated that embodiments of the present invention are not limited to employing the techniques disclosed in the '334 and '401 applications to make a recommendation. Any suitable technique for making a recommendation may be employed. Further, the techniques described separately above may be combined as needed to generate a recommendation. Embodiments of the invention are not limited to being implemented in any particular manner.

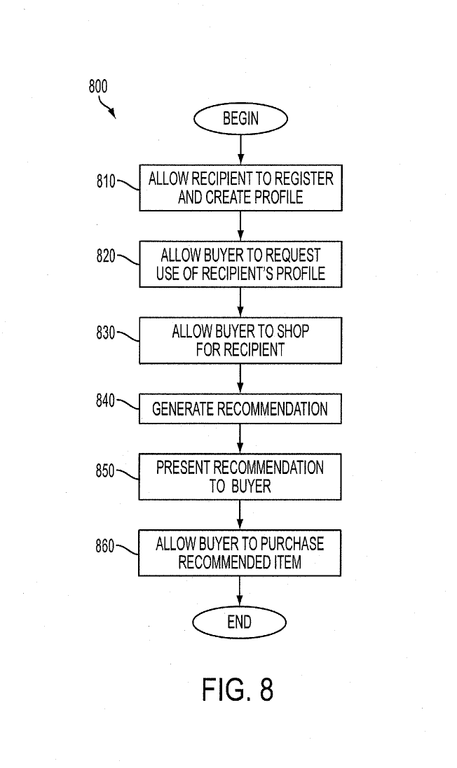

FIG. 8 depicts an example process 800 which may be performed to enable a buyer to shop for a recipient with confidence. Example process 800 begins in act 810, wherein a recipient is allowed to register and create a profile. A recipient may register and create a profile, for example, using consumer registration controller 101 (FIG. 1). Consumer registration controller 101 may enable the recipient to submit profile information including (as examples) his/her age, gender, body shape, item preferences (e.g., brands and sizes of clothing that fit them well), style preferences, fit preferences, and/or any other suitable information.

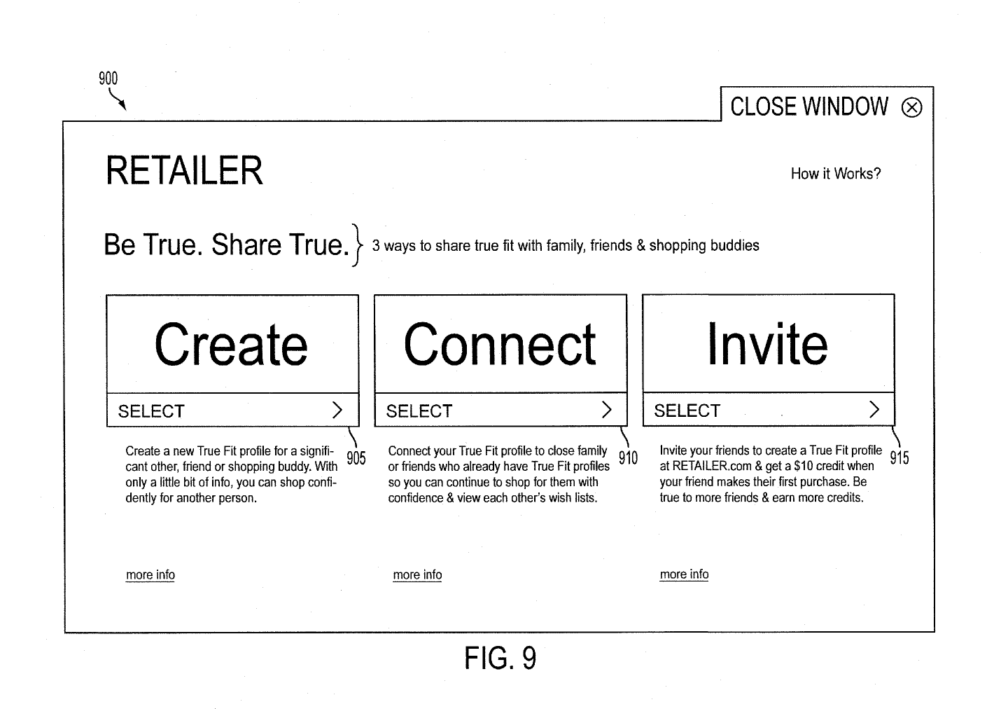

An example interface 900 which enables a recipient to initiate registration and creation of a profile is shown in FIG. 9. Example interface 900 is a web-based interface (e.g., for presentation via an e-commerce website) that may, for example, be defined and presented by shopping agent 104 (FIG. 1). Using example interface 900, a recipient may initiate registration and profile creation by clicking link 905. Example interface 900 also allows a recipient to initiate sharing a previously created profile with others (e.g., potential buyers) by clicking link 910, and allows a potential buyer to encourage a user to register and create a profile, so that the potential buyer may then use the profile to purchase items for the user, by clicking link 915.

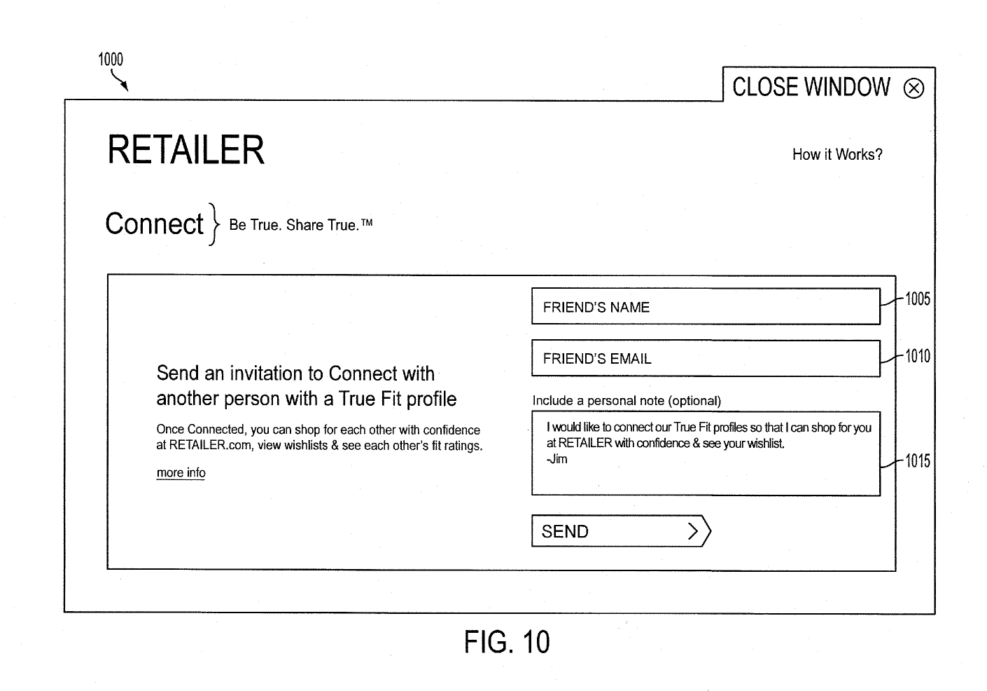

At the completion of act 810, example process 800 proceeds to act 820, wherein a buyer is allowed to request use of the recipient's profile, created in act 810, to shop for the recipient. This may be performed in any of numerous ways. An example interface 1000 which enables a buyer to request use of a recipient's profile is shown in FIG. 10. Example interface 1000 allows a buyer to identify the recipient by name by submitting input to box 1005, and by email address by submitting input to box 1010. Box 1015 allows the buyer to submit input that will be sent to the recipient (e.g., via email) with the request to use the profile. In some embodiments, a recipient's permission may be a prerequisite to a buyer being able to use his/her profile, so that the recipient's privacy may be preserved. As noted above, some embodiments may enable a recipient to designate certain attributes (e.g., sizes, measurements, etc.) reflected in his/her profile as private, so that a buyer may not gain access to this information while shopping for the recipient, unless the recipient so consents.

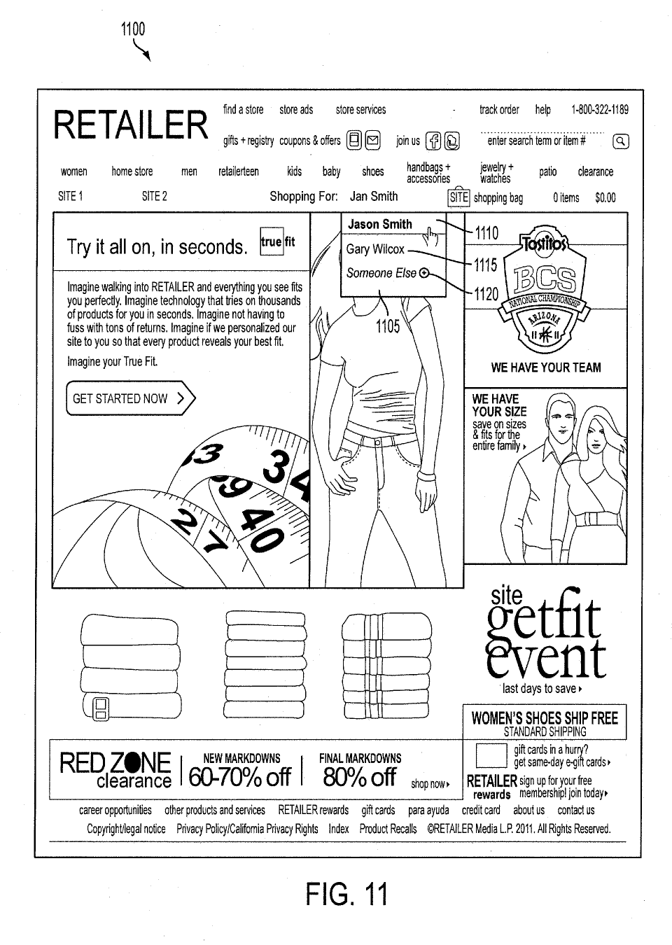

At the completion of act 820, example process 800 proceeds to act 830, wherein the buyer is allowed to shop for the recipient. For example, the buyer may examine the various offerings of an e-commerce website, displayed in a retail setting, etc. An example interface 1100 which enables a buyer to shop for a recipient is shown in FIG. 11. Example interface 1100 shows a home page presented by an e-commerce website. Clicking on drop-down menu 1105 causes a list of two intended recipients (e.g., identified when the buyer “signed in” or otherwise identified himself/herself to the website) to be presented. The buyer may select either of the identified recipients by clicking one of entries 1110 and 1115, or identify another recipient by clicking on entry 1120.

Example process 800 then proceeds to act 840, wherein one or more recommendations are generated and presented to the buyer. A recommendation may be generated, for example, using the techniques described above, and/or one or more other techniques.

In act 850, the generated recommendation is presented to the buyer. Presentation of a recommendation may take any of numerous forms. For example, presenting a recommendation may include displaying, while the buyer shops for a recipient, information (e.g., images, video, descriptions and/or other information) relating to one or more items deemed likely to suit the recipient, such as those determined to exemplify preferences identified by the recipient during the creation of his/her profile in act 810.

Alternatively, making a recommendation may entail suggesting attributes of a particular item chosen by the buyer, based on knowledge of the recipient's preferences. For example, if the buyer indicates an interest in purchasing a particular item for the recipient, then a size, color and/or other attribute for the considered item may be suggested to the buyer, based on preferences expressed in the recipient's profile. As noted above, some embodiments may prevent some information from being presented to the buyer as part of a recommendation. For example, if the recipient designated his/her size as private, then this information may not be presented to the buyer. Instead, the buyer may, for example, be presented with an indication that the recipient has requested that this information remain private, and informed that the item, if purchased, will be delivered to the recipient in the appropriate size.

Example process 800 then proceeds to act 860, wherein a purchase of a recommended item by the buyer is facilitated. For example, if act 830 involves allowing the buyer to shop for the recipient on an e-commerce website, then act 860 may include enabling the buyer to complete a purchase of a recommended item on the website. Of course, act 860 may include allowing a buyer to purchase a recommended item in any suitable way (e.g., in a retail setting), as embodiments of the invention are not limited in this respect. At the completion of act 860, example process 800 completes.

It should be appreciated that numerous variations on example process 800 are possible. For example, some variations may include acts which are not described above, may omit one or more of the acts described above, may provide for one or more acts to be performed differently than in the manner(s) described above, and/or may provide for the acts described above to be performed in a different sequence than that which is described. In one example variation, act 810 may involve a third party registering and creating a profile for a recipient, rather than the recipient himself/herself. For example, if the recipient is a small child, the recipient's parent may register and create a profile for the recipient. In another example variation, rather than allowing a buyer to request use of a recipient's profile, a recipient may invite a buyer to do so. Any of numerous variations are possible, as embodiments of the invention are not limited in this respect.

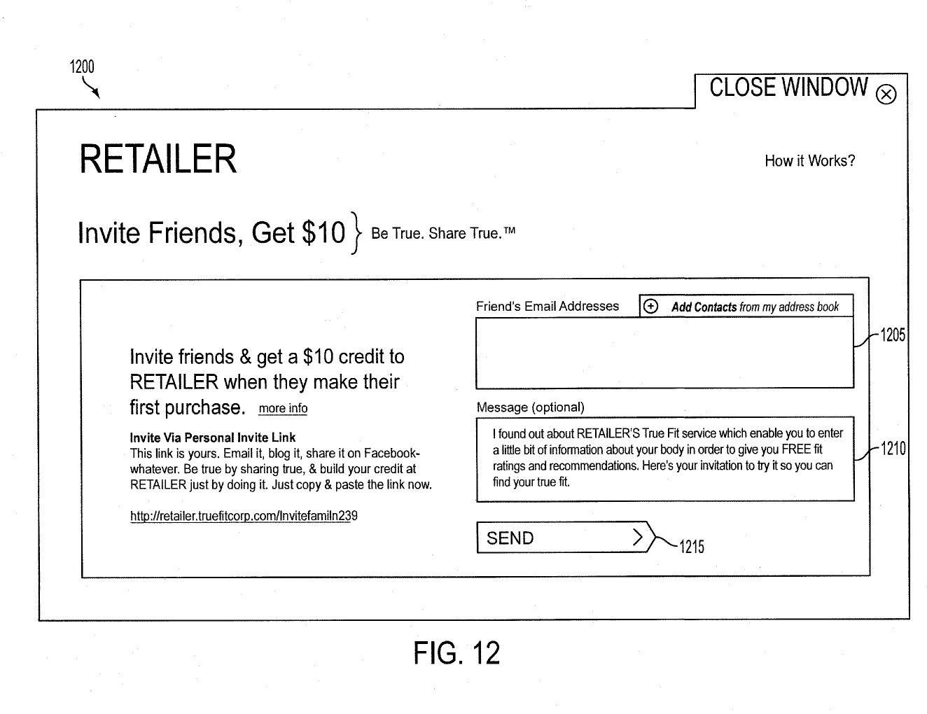

Some embodiments of the invention may enable a buyer or other user to encourage a potential recipient to register and create a profile for use. An example interface 1200 which a user may employ for this purpose is shown in FIG. 12. Example interface 1200 allows the user to submit a potential recipient's e-mail address to box 1205, and to specify a message to be sent (e.g., via email) to the potential recipient in box 1210. By clicking link 1215, the user may initiate transmission of an invitation to the potential recipient.

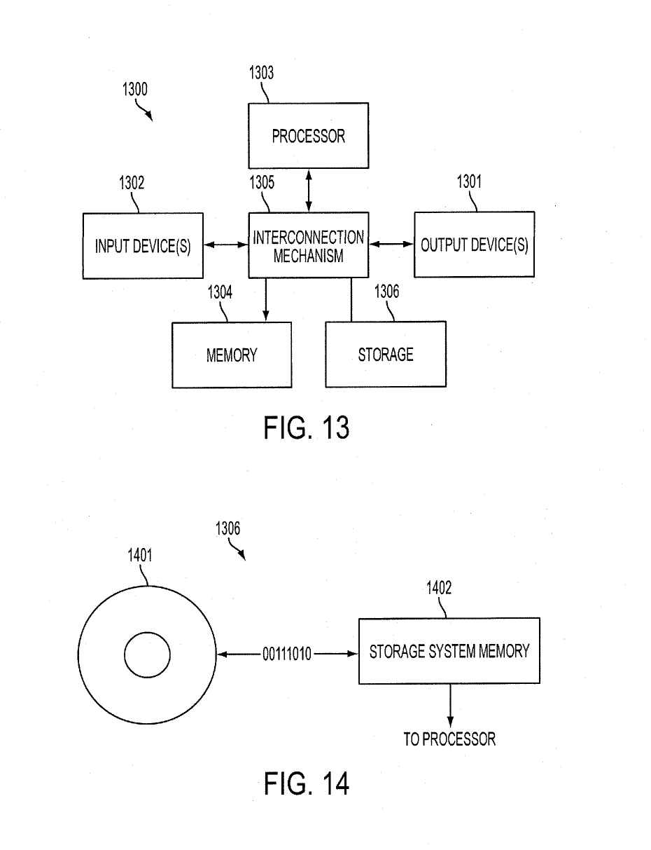

As should be appreciated from the description above, various aspects of the invention may be implemented via one or more computer systems, such as the example computer system 1300 shown in FIG. 13. Computer system 1300 includes input device(s) 1302, output device(s) 1301, processor 1303, memory system 1304 and storage 1306, all of which are coupled, directly or indirectly, via interconnection mechanism 1305, which may comprise one or more buses, switches, networks and/or any other suitable interconnection. The input device(s) 1302 receive(s) input from a user or machine (e.g., a human operator), and the output device(s) 1301 display(s) or transmit(s) information to a user or machine (e.g., a liquid crystal display). The input and output device(s) can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

The processor 1303 typically executes a computer program called an operating system which controls the execution of other computer programs, and provides scheduling, input/output and other device control, accounting, compilation, storage assignment, data management, memory management, communication and dataflow control. Collectively, the processor and operating system define the computer platform for which application programs and other computer program languages are written.

Processor 1303 may also execute one or more computer programs to implement various functions. These computer programs may be written in any type of computer program language, including a procedural programming language, object-oriented programming language, macro language, or combination thereof. These computer programs may be stored in storage system 1306. Storage system 1306 may hold information on a volatile or non-volatile medium, and may be fixed or removable. Storage system 1306 is shown in greater detail in FIG. 14.

Storage system 1306 may include a tangible computer-readable and -writable non-volatile recording medium 1401, on which signals are stored that define a computer program or information to be used by the program. The recording medium may, for example, be disk memory, flash memory, and/or any other article(s) of manufacture usable to record and store information. Typically, in operation, the processor 1303 causes data to be read from the nonvolatile recording medium 1401 into a volatile memory 1402 (e.g., a random access memory, or RAM) that allows for faster access to the information by the processor 1303 than does the medium 1401. The memory 1302 may be located in the storage system 1306 or in memory system 1304. The processor 1303 generally manipulates the data within the integrated circuit memory 1304, 1402 and then copies the data to the medium 1301 after processing is completed. A variety of mechanisms are known for managing data movement between the medium 1301 and the integrated circuit memory element 1304, 1402, and the invention is not limited to any mechanism, whether now known or later developed. The invention is also not limited to a particular memory system 1304 or storage system 1306.

It should also be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound-generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer-readable medium (or multiple computer-readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or one or more other non-transitory, tangible computer-readable storage media) encoded with one or more programs that, when executed on one or more computers or other processors, perform methods that implement the various embodiments of the invention discussed above. The computer-readable medium or media may, for example, be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than that which is illustrated and described, which may include performing some acts simultaneously, even though shown as sequential acts in the illustrative embodiments described herein.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method, comprising:
(A) receiving a request, from a buyer, for a recommendation of an item for a recipient other than the buyer;
(B) generating a recommendation based at least in part on an analysis of information relating to the recipient, the information relating to the recipient comprising at least one preference, measurement, size and/or favorite item of the recipient; and
(C) causing the recommendation generated in (B) to be made available to the buyer.

2. The method of claim 1, further comprising, prior to (A), enabling the recipient or a representative of the recipient to create a profile comprising the information that is analyzed to generate the recommendation in (B).

3. The method of claim 2, wherein the profile includes information comprising the recipient's age, the recipient's gender, at least one brand and/or size of item favored by the recipient, and/or at least one body shape attribute of the recipient.

4. The method of claim 2, wherein access to at least a portion of the information in the profile is restricted to the recipient or the representative of the recipient.

5. The method of claim 1, wherein (C) comprises causing the recommendation to be presented to the buyer via at least one of an e-commerce website, an application executing on a mobile device, and an application executing in a retail setting.

6. The method of claim 1, wherein the recommendation for which the request is received in (A) is a recommendation of a size of an item that is selected by the buyer.

7. The method of claim 1, wherein the recommendation for which the request is received in (A) is a recommendation for an item which suits the recipient.

8. The method of claim 1, wherein the recommendation for which the request is received in (A) is a recommendation for an item of apparel or footwear.

9. The method of claim 1, further comprising an act of:
(D) enabling the buyer to purchase an item based on the recommendation.

10. At least one computer-readable medium having instructions encoded thereon which, when executed, perform a method comprising:
(A) receiving a request, from a buyer, for a recommendation of an item for a recipient other than the buyer;
(B) generating a recommendation based at least in part on an analysis of information relating to the recipient, the information relating to the recipient comprising at least one preference, measurement, size and/or favorite item of the recipient; and
(C) causing the recommendation generated in (B) to be made available to the buyer.

11. The at least one computer-readable medium of claim 10, wherein the method further comprises, prior to (A), enabling the recipient or a representative of the recipient to create a profile comprising the information that is analyzed to generate the recommendation in (B).

12. The at least one computer-readable medium of claim 11, wherein the profile includes information comprising the recipient's age, the recipient's gender, at least one brand and/or size of item favored by the recipient, and/or at least one body shape attribute of the recipient.

13. The at least one computer-readable medium of claim 11, wherein access to at least a portion of the information in the profile is restricted to the recipient or the representative of the recipient.

14. The at least one computer-readable medium of claim 10, wherein (C) comprises causing the recommendation to be presented to the buyer via at least one of an e-commerce website, an application executing on a mobile device, and an application executing in a retail setting.

15. The at least one computer-readable medium of claim 10, wherein the recommendation for which the request is received in (A) is a recommendation of a size of an item that is selected by the buyer.

16. The at least one computer-readable medium of claim 10, wherein the recommendation for which the request is received in (A) is a recommendation for an item which suits the recipient.

17. The at least one computer-readable medium of claim 10, wherein the recommendation for which the request is received in (A) is a recommendation for an item of apparel or footwear.

18. The at least one computer-readable medium of claim 10, wherein the method further comprises an act of:
(D) enabling the buyer to purchase an item based on the recommendation.

19. A system, comprising:
at least one storage facility storing information relating to a recipient, the information comprising at least one preference, measurement, size and/or favorite item of the recipient;
at least one computer processor programmed to:
receive a request, from a buyer, for a recommendation of an item for a recipient;
generate a recommendation based at least in part on an analysis of the information stored in the at least one storage facility; and
cause the recommendation to be made available to the buyer.

20. The system of claim 19, wherein the at least one computer processor is further programmed to enable the recipient or a representative of the recipient to create a profile comprising the information, and wherein the at least one storage facility stores the profile.
